(19) United States
(12) Patent Application Publication
(10) Pub. No.: US 2017/0222456 A1
(43) Pub. Date: Aug. 3, 2017

(54) CHARGING STYLUS INSIDE HINGE OF PORTABLE COMPUTING DEVICE

(71) Applicant: Google Inc., Mountain View, CA (US)

(72) Inventors: Alberto Martin PEREZ, Mountain View, CA (US); Katie Leah ROBERTS-HOFFMAN, Mountain View, CA (US)

(21) Appl. No.: 15/010,978

(22) Filed: Jan. 29, 2016

(51) Int. Cl. H02J 7/00; G06F 1/16

(52) U.S. Cl. CPC H02J 7/0044; G06F 1/1618; G06F 1/1681

(57) ABSTRACT

A portable computing device may comprise a lid, a base hingedly attached to the lid, and a hinge at an intersection between the lid and the base. The hinge may define a recess configured to receive a stylus. The hinge may include circuitry configured to provide electrical power to charge a battery in the stylus while the stylus is inside the recess.

### TECHNICAL FIELD

This description relates to portable computing devices.

### BACKGROUND

Portable computing devices may provide convenience to users. Users may be able to work on their portable computing devices such as laptop computers in a variety of locations.

### SUMMARY

A portable computing device such as a laptop computer may store a stylus, which may include circuitry for writing on a display of the laptop computing device, in a hinge of the laptop computing device. The laptop computer may recharge a battery within the stylus while the stylus is in the hinge.

According to one general aspect, a portable computing device may comprise a lid, a base hingedly attached to the lid, and a hinge at an intersection between the lid and the base. The hinge may define a recess configured to receive a stylus. The hinge may include circuitry configured to provide electrical power to charge a battery in the stylus while the stylus is inside the recess.

According to another general aspect, a non-transitory computer-readable storage medium may comprise instructions stored thereon for charging a stylus inside a portable computing device. The instructions, when executed by at least one processor, may be configured to cause the portable computing device to at least determine whether a stylus is inside a recess defined by the portable computing device and is less than fully charged, provide electrical power to the stylus if the stylus is inside the recess defined by the portable computing device and is less than fully charged, and not provide electrical power to the stylus if the stylus is not inside the recess defined by the portable computing device or if the stylus is fully charged.

According to another general aspect, a portable computing device may comprise a lid with a display on a first side of the lid, a base hingedly attached to the lid, the base comprising a keyboard on a first side of the base, and a hinge at an intersection between the lid and the base. The hinge may be configured to rotate the lid three hundred sixty degrees (360°) from a first position in which the display faces the keyboard to a second position in which a second side of the lid, opposite from the display, faces a second side of the base, opposite from the keyboard, the hinge defining a recess configured to receive a stylus. The portable computing device may include circuitry configured to determine whether a stylus inside the recess is less than fully charged, provide electrical power to the stylus if the stylus is inside the recess and is less than fully charged, not provide electrical power to the stylus if the stylus inside the recess is fully charged, and provide firmware updates to the stylus.

The details of one or more implementations are set forth in the accompanying drawings and the description below. Other features will be apparent from the description and drawings, and from the claims.

### BRIEF DESCRIPTION OF THE DRAWINGS

FIG. 1A is a perspective view of a laptop computer according to an example embodiment.

FIG. 1B is a side view of the laptop computer in an open position according to an example embodiment.

FIG. 1C is a side view of the laptop computer in a closed position according to an example embodiment.

FIG. 1D is a side view of the laptop computer in a tablet position according to an example embodiment.

FIG. 1E is a perspective view of the laptop computer in the open position according to another example embodiment.

FIG. 1F is a rear view of the laptop computer in the closed position according to the example embodiment shown in FIG. 1E.

FIG. 2A is a cross-sectional view of a hinge of the laptop computer showing a receptacle for holding a stylus according to an example embodiment.

FIG. 2B is a cross-sectional view of a hinge of the laptop computer showing the receptacle for holding the stylus according to another example embodiment.

FIG. 2C is a cross-sectional view of a hinge of the laptop computer showing the receptacle for holding the stylus according to another example embodiment.

FIG. 3A is a side view of the stylus according to an example embodiment.

FIG. 3B is a side view of the stylus according to another example embodiment.

FIG. 3C is a side view of the stylus according to another example embodiment.

FIG. 3D is an end view of the stylus according to another example embodiment.

FIG. 4 is a flowchart showing a method performed by the laptop computer according to an example embodiment.

FIG. 5 shows an example of a computer device and a mobile computer device that can be used to implement the techniques described here.

### DETAILED DESCRIPTION

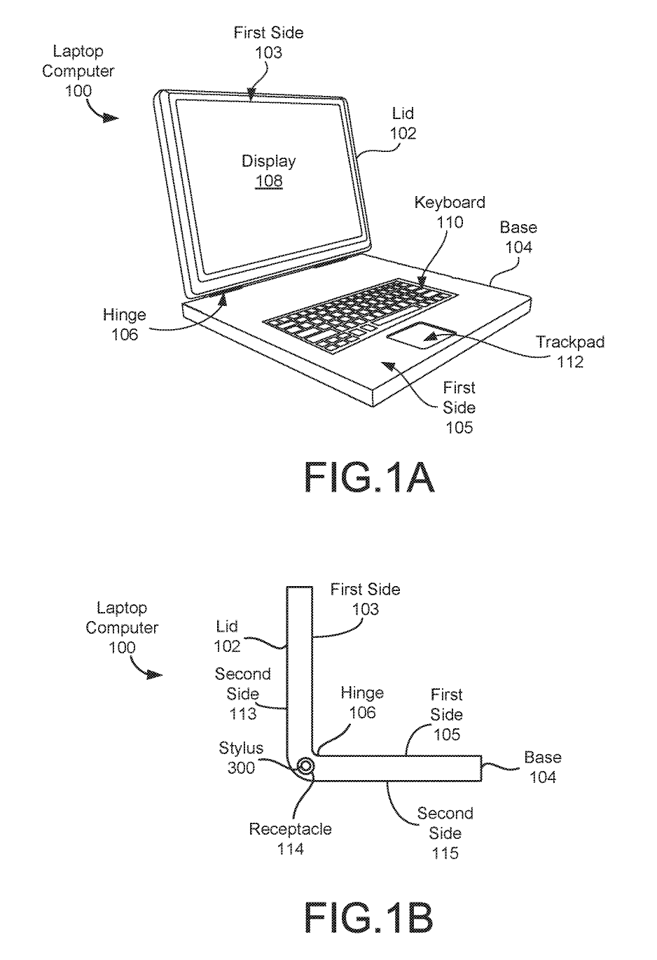

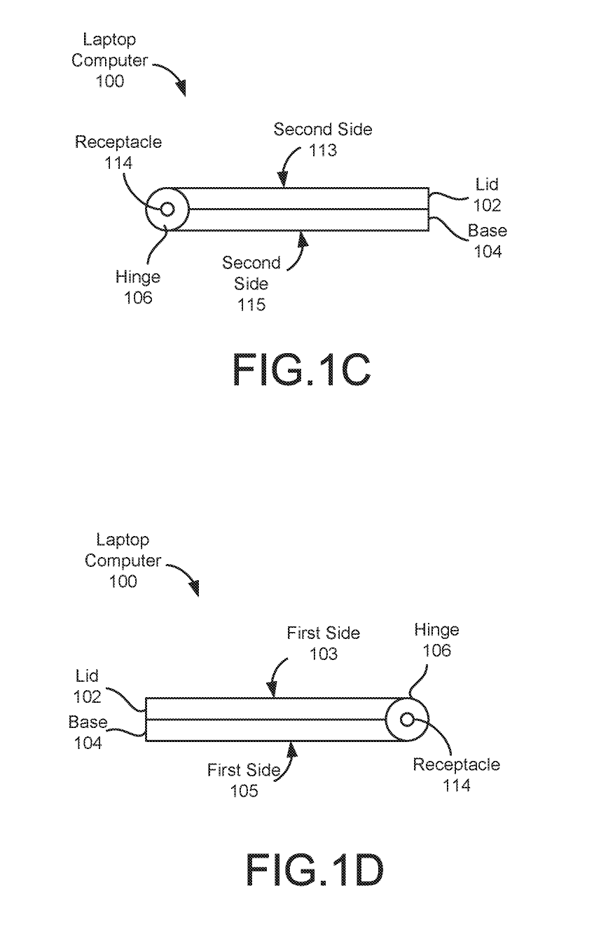

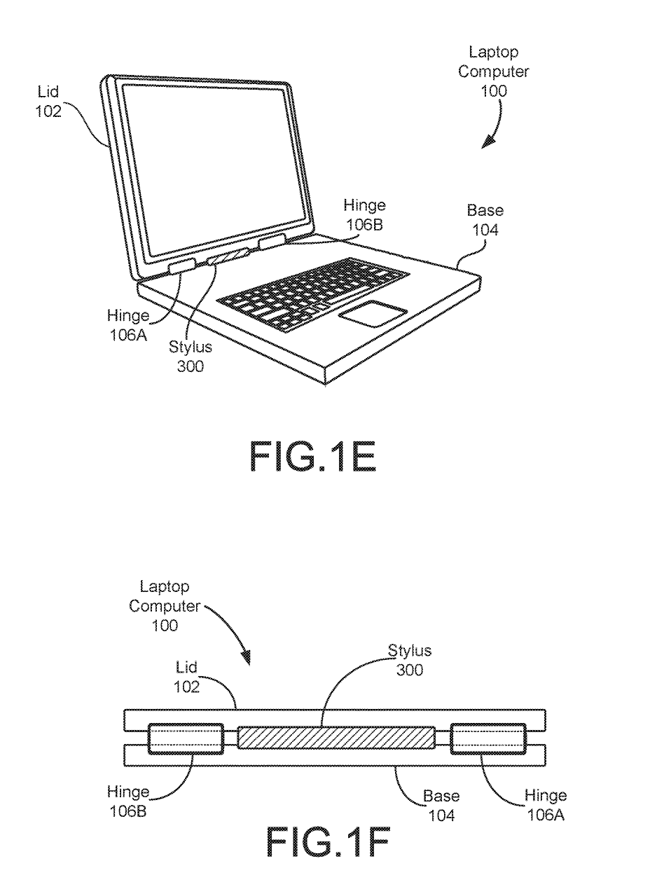

FIG. 1A is a perspective view of a laptop computer 100 according to an example embodiment. The laptop computer 100 is an example of a portable computing device. In this example, the laptop computer 100 may include a lid 102 and a base 104. The base 104 may be hingedly attached to the lid 102. The base 104 may be hingedly attached to the lid 102 by a hinge 106. The hinge 106 may be located at an intersection between the lid 102 and the base 104. The hinge 106 may enable the base 104 and lid 102 to rotate with respect to each other. In some implementations, the lid may rotate three hundred sixty degrees (360°) with respect to the base. While not shown in FIG. 1A, the hinge 106 may define a recess for receiving an electronic stylus. The hinge 106 may include circuitry configured to recharge a battery within the stylus while the stylus is inside the recess.

The lid 102 may include a display 108 on a first side 103 of the lid 102. The display 108 may present images to a user, and may include a liquid crystal display (LCD), light-emitting diode (LED) display, plasma display, or other display technology.

The base 104 may include a keyboard 110 and/or a trackpad 112 on a first side 105 of the base 104. The keyboard 110 may include keys to receive alphanumeric input from the user. The trackpad 112 may include a surface that receives tactile input from the user.

FIG. 1B is a side view of the laptop computer 100 in an open position according to an example embodiment. As shown in FIG. 1B, the lid 102 and base 104 are hingedly attached to each other by the hinge 106. The hinge 106 may include a barrel hinge or a piano hinge, as non-limiting examples.

The hinge 106 may define a receptacle 114. The receptacle 114 may be cylindrical, and may extend from an end of the hinge 106 to an opposite end of the hinge 106 in a direction parallel to the intersection and/or attachment of the base 104 and the lid 102. In an example in which the hinge 106 is a barrel hinge, the receptacle 114 may be built into an air gap of the barrel hinge so that the receptacle 114 and stylus 300 do not take up additional space inside the base 104. In an example in which the hinge 106 is a piano hinge, the receptacle 114 may be built into the barrel of the piano hinge so that the receptacle 114 and stylus 300 do not take up additional space inside the base 104.

The receptacle 114 may receive a stylus 300. The stylus 300 may extend into the receptacle 114. The stylus 300, when removed from the receptacle 114, may provide input into the display 108 (not shown in FIG. 1B), such as by inducing magnetic fields, generating electric fields, and/or applying pressure onto the display 108, allowing the user to write onto the display 108 as if writing onto a piece of paper. Storing the stylus 300 in the receptacle 114 of the hinge 106 may save space, allowing more room for other components inside the base 104 of the laptop computer 100.

FIG. 1C is a side view of the laptop computer 100 in a closed position according to an example embodiment. In this example, the first sides 103, 105 (not labeled in FIG. 1C) of the lid 102 and base 104 face each other, and/or the display 108 (not shown in FIG. 1C) and keyboard 110 (not shown in FIG. 1C) face each other, in the closed position. In this example, second sides 113, 115 of the lid 102 and base 104 (which are opposite from the first sides 103, 105) are opposite from each other, facing away from each other.

FIG. 1D is a side view of the laptop computer 100 in a tablet position according to an example embodiment. In this example, the lid 102 and/or base 104 have been rotated three hundred sixty degrees (360°) with respect to each other from the closed position of FIG. 1C, placing the laptop computer 100 into a tablet position in which the user can face the first side 103 of the lid 102 and the display 108 (not shown in FIG. 1D), and can hold and interact with the laptop computer 100 like a tablet computing device. In this example, the first sides 103, 105 are opposite from each other, facing away from each other. In this example, the second sides 113, 115 (not labeled in FIG. 1D), opposite from the display 108 (not shown in FIG. 1D) and keyboard 110 (not shown in FIG. 1D), face away from each other.

FIG. 1E is a perspective view of the laptop computer 100 in the open position according to another example embodiment. In this example, the laptop computer 100 may include two hinges 106A, 106B hingedly connecting the lid 102 to the base 104. The stylus 300 may be stored in a receptacle at an intersection of the lid 102 and the base 104 between the two hinges 106A, 106B. The lid 102 may define a lid recess forming part of the receptacle for storing the stylus 300, and the base 104 may define a base recess forming another part of the receptacle for storing the stylus 300. Circuitry for recharging and/or communicating with the stylus 300 may be included in the portion of the receptacle defined by the lid 102 and/or the portion of the receptacle defined by the base 104.

FIG. 1F is a rear view of the laptop computer 100 in the closed position according to the example embodiment shown in FIG. 1E. As shown in FIG. 1F, the stylus in this example is stored in a receptacle between the two hinges 106A, 106B.

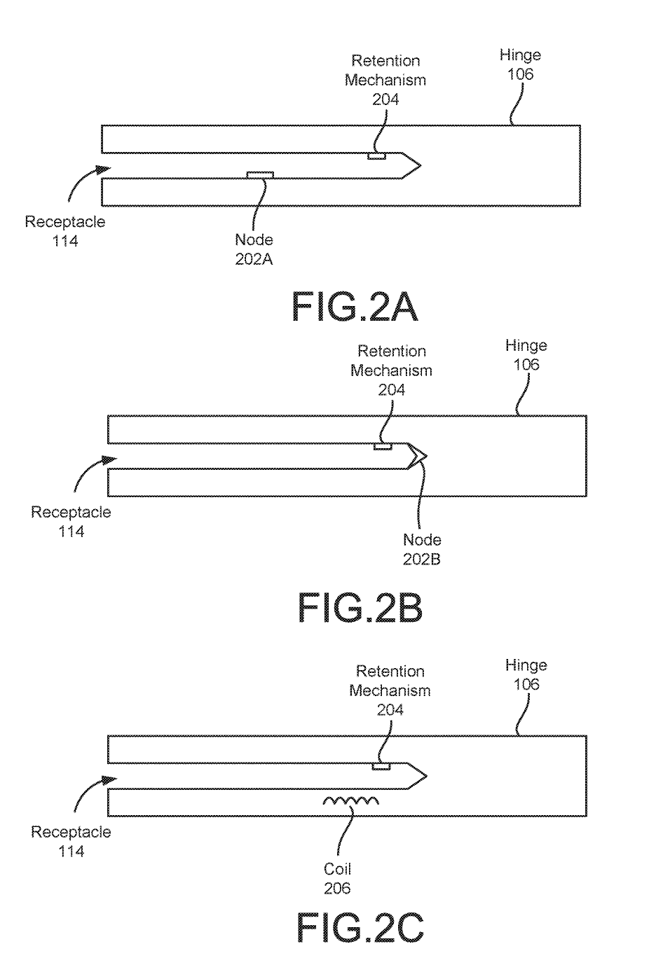

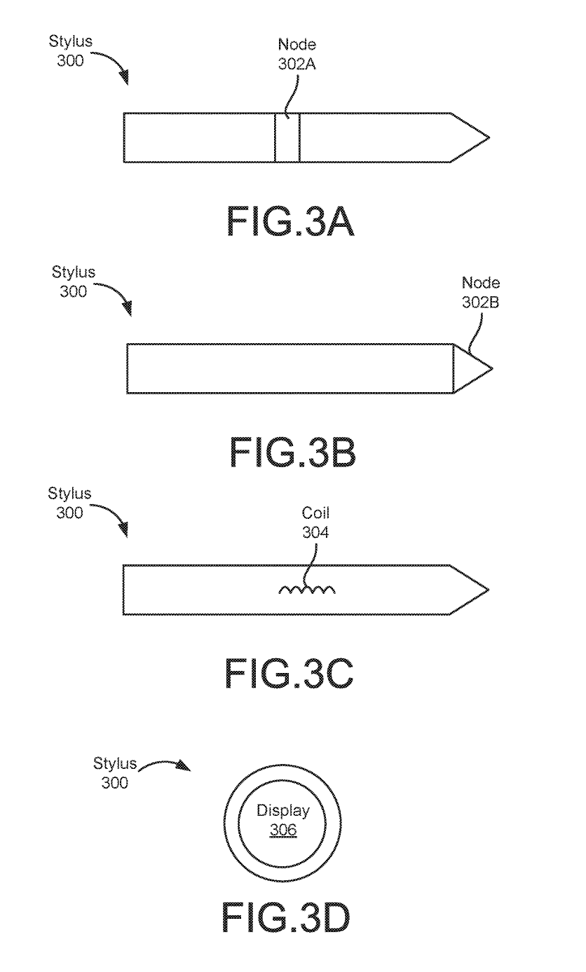

FIG. 2A is a cross-sectional view of the hinge 106 of the laptop computer 100 showing the receptacle 114 for holding the stylus 300 (not shown in FIG. 2A) according to an example embodiment. As shown in FIG. 2A, a portion of the receptacle 114 can be cylindrical. In this example, the circuitry of the hinge 106 may include an electrical node 202A for recharging a battery within the stylus 300 in an example in which a node on the stylus 300 extends around a perimeter of the stylus 300. The hinge 106 may also include a retention mechanism 204 for holding the stylus 300 inside the receptacle 114. The retention mechanism 204 may engage when the stylus 300 is fully inserted into the receptacle 114, and may release the stylus 300 in response to pressure on the stylus 300 after the engagement. An example stylus 300 for recharging by the node 202A is shown in FIG. 3A.

FIG. 2B is a cross-sectional view of the hinge 106 of the laptop computer 100 showing the receptacle 114 for holding the stylus 300 according to another example embodiment. In this example, the circuitry of the hinge 106 may include an electrical node 202B for charging the stylus 300 when the stylus 300 includes a node at an end portion of the stylus 300. An example stylus 300 for recharging by the node 202B is shown in FIG. 3B.

FIG. 2C is a cross-sectional view of the hinge 106 of the laptop computer 100 showing the receptacle 114 for holding the stylus 300 according to another example embodiment. In this example, the hinge 106 may recharge a battery within the stylus 300 through inductive charging. The circuitry of the hinge 106 may include a coil 206 through which an electric current may flow to induce a varying amount of magnetic flux to recharge a battery within the stylus 300.

FIG. 3A is a side view of the stylus 300 according to an example embodiment. The stylus 300 may include an electronic stylus for providing input to the display 108 and/or trackpad 112. As shown in FIG. 3A, the stylus 300 may have a cylindrical shape with a conical end. The stylus 300 may include an electrical node 302A that extends around a perimeter and/or circumference of the stylus 300. The node 302A may contact the node 202A in the example hinge 106 of FIG. 2A, to receive electrical power from the laptop computer 100 to recharge a battery within the stylus 300.

FIG. 3B is a side view of the stylus 300 according to another example embodiment. In this example, the stylus 300 may include an electrical node 302B at an end of the stylus 300. The node 302B may contact the node 202B in the example hinge 106 of FIG. 2B, to receive electrical power from the laptop computer 100 to recharge the stylus 300.

FIG. 3C is a side view of the stylus 300 according to another example embodiment. In this example, the stylus 300 may receive power from the hinge 106 through inductive charging. The stylus 300 may include a coil 304 through which a varying amount of magnetic flux may propagate to induce an electric current in the coil 304 to recharge a battery within the stylus 300. The varying amount of magnetic flux may be provided by the hinge 106 of the laptop computer 100.

FIG. 3D is an end view of the stylus 300 according to another example embodiment. In this example, the stylus 300 may include a display 306 and/or visual indicator at an end portion of the stylus. The display 306 may be visible to the user when the stylus is fully inserted in the receptacle 114. In an example embodiment, the display 306 and/or visual indicator may provide status updates, such as colors to indicate whether the stylus 300 is fully charged. In another example embodiment, the display 306 may indicate a time of day. In an example embodiment, the display 306 may indicate a time of day when the display 108 of the laptop computer 100 has powered off, saving power because the display 306 of the stylus 300 consumes less power than the display 108 of the laptop computer 100.

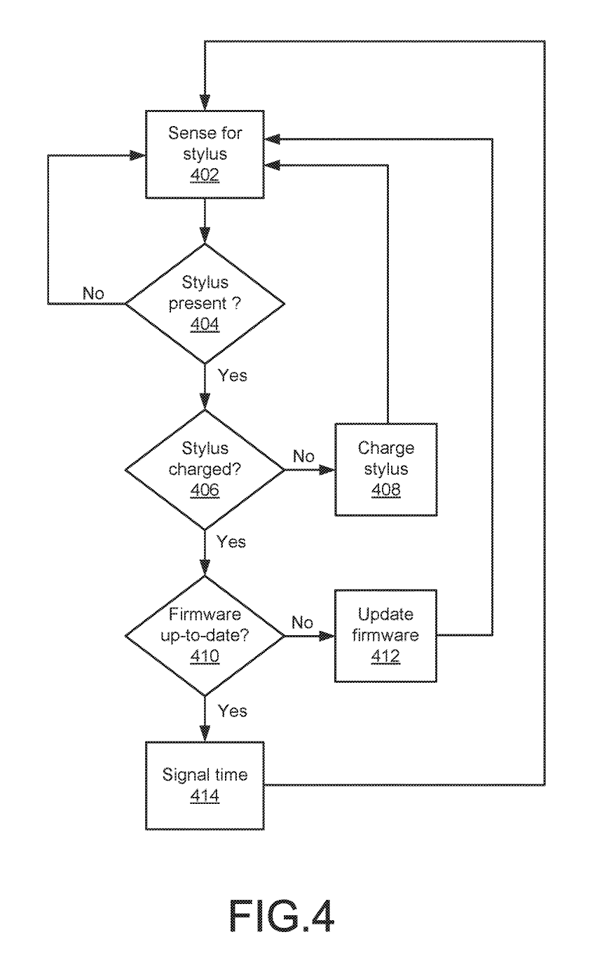

FIG. 4 is a flowchart showing a method performed by a portable computing device such as the laptop computer 100 according to an example embodiment. The laptop computer 100 may include a non-transitory computer-readable storage medium comprising instructions stored thereon that, when executed by at least one processor, are configured to cause the laptop computer 100 to perform any combination of the functions, methods, and/or techniques described herein with respect to FIG. 4 or elsewhere in this disclosure. In this example, the laptop computer 100 may sense for the stylus 300 (402). Based on sensing for the stylus 300, the laptop computer 100 may determine whether the stylus 300 is present in the receptacle 114 (404). The laptop computer 100 may sense for the stylus 300 and/or determine whether the stylus 300 is in the receptacle 114 by determining whether the retention mechanism 204 is engaged, whether the node 302A, 302B of the stylus 300 is in contact with the node 202A, 202B of the hinge 106, and/or whether an electronic device is in proximity to the coil 206 of the hinge 106.

If the stylus 300 is not present, then the laptop computer 100 may continue sensing for the stylus (402). If the stylus 300 is present, then the laptop computer 100 may determine whether the stylus 300 is fully charged (406). The laptop computer 100 may determine whether the stylus 300 is fully charged based on a signal received from the stylus 300. If the stylus 300 is not fully charged, then the laptop computer 100 may charge the stylus 300 (408). The laptop computer 100 may charge the stylus 300 by providing electrical power to the stylus 300 via the nodes 202A, 302A, 202B, 302B and/or coils 206, 304.

If the stylus 300 is fully charged, then the laptop computer 100 may determine whether the firmware of the stylus 300 is up-to-date (410). The laptop computer 100 may determine whether the firmware is up-to-date by comparing a firmware version of the stylus 300, as indicated by a signal received from the stylus 300, to a most recent firmware version stored on the laptop computer 100, which the laptop computer 100 may have received from a remote server via the Internet.

If the firmware is not up-to-date, then the laptop computer 100 may update the firmware (412) of the stylus 300. The laptop computer 100 may update the firmware by sending a file including the firmware, or a part of the firmware to update, to the stylus 300 via the nodes 202A, 302A, 202B, 302B and/or coils 206, 304.

If the firmware is up-to-date, then the laptop computer 100 may signal the time (414) to the stylus 300. The laptop computer 100 may signal the time of day to the stylus 300 so that the stylus 300 may present the time in the display 306.

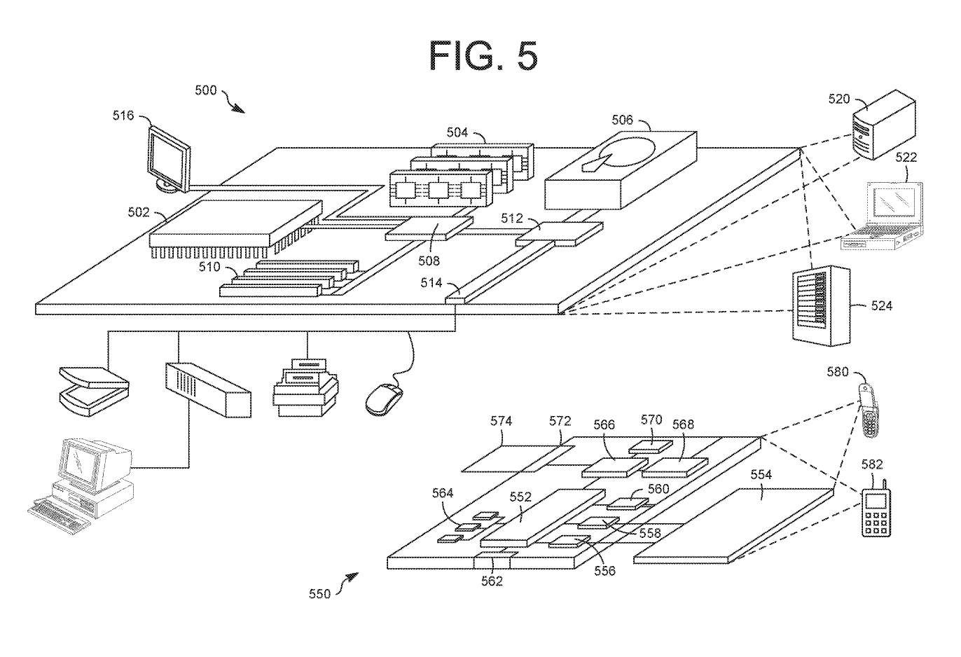

FIG. 5 shows an example of a generic computer device 500 and a generic mobile computer device 550, which may be used with the techniques described here. Computing device 500 is intended to represent various forms of digital computers, such as laptops, desktops, workstations, personal digital assistants, servers, blade servers, mainframes, and other appropriate computers. Computing device 550 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

Computing device 500 includes a processor 502, memory 504, a storage device 506, a high-speed interface 508 connecting to memory 504 and high-speed expansion ports 510, and a low speed interface 512 connecting to low speed bus 514 and storage device 506. Each of the components 502, 504, 506, 508, 510, and 512, are interconnected using various busses, and may be mounted on a common motherboard or in other manners as appropriate. The processor 502 can process instructions for execution within the computing device 500, including instructions stored in the memory 504 or on the storage device 506 to display graphical information for a GUI on an external input/output device, such as display 516 coupled to high speed interface 508. In other implementations, multiple processors and/or multiple buses may be used, as appropriate, along with multiple memories and types of memory. Also, multiple computing devices 500 may be connected, with each device providing portions of the necessary operations (e.g., as a server bank, a group of blade servers, or a multi-processor system).

The memory 504 stores information within the computing device 500. In one implementation, the memory 504 is a volatile memory unit or units. In another implementation, the memory 504 is a non-volatile memory unit or units. The memory 504 may also be another form of computer-readable medium, such as a magnetic or optical disk.

The storage device 506 is capable of providing mass storage for the computing device 500. In one implementation, the storage device 506 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 504, the storage device 506, or memory on processor 502.

The high speed controller 508 manages bandwidth-intensive operations for the computing device 500, while the low speed controller 512 manages lower bandwidth-intensive operations. Such allocation of functions is exemplary only. In one implementation, the high-speed controller 508 is coupled to memory 504, display 516 (e.g., through a graphics processor or accelerator), and to high-speed expansion ports 510, which may accept various expansion cards (not shown). In the implementation, low-speed controller 512 is coupled to storage device 506 and low-speed expansion port 514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 500 may be implemented in a number of different forms, as shown in the figure. For example, it may be implemented as a standard server 520, or multiple times in a group of such servers. It may also be implemented as part of a rack server system 524. In addition, it may be implemented in a personal computer such as a laptop computer 522. Alternatively, components from computing device 500 may be combined with other components in a mobile device (not shown), such as device 550. Each of such devices may contain one or more of computing device 500, 550, and an entire system may be made up of multiple computing devices 500, 550 communicating with each other.

Computing device 550 includes a processor 552, memory 564, an input/output device such as a display 554, a communication interface 566, and a transceiver 568, among other components. The device 550 may also be provided with a storage device, such as a microdrive or other device, to provide additional storage. Each of the components 550, 552, 564, 554, 566, and 568, are interconnected using various buses, and several of the components may be mounted on a common motherboard or in other manners as appropriate.

The processor 552 can execute instructions within the computing device 550, including instructions stored in the memory 564. The processor may be implemented as a chipset of chips that include separate and multiple analog and digital processors. The processor may provide, for example, for coordination of the other components of the device 550, such as control of user interfaces, applications run by device 550, and wireless communication by device 550.

Processor 552 may communicate with a user through control interface 558 and display interface 556 coupled to a display 554. The display 554 may be, for example, a TFT LCD (Thin-Film-Transistor Liquid Crystal Display) or an OLED (Organic Light Emitting Diode) display, or other appropriate display technology. The display interface 556 may comprise appropriate circuitry for driving the display 554 to present graphical and other information to a user. The control interface 558 may receive commands from a user and convert them for submission to the processor 552. In addition, an external interface 562 may be provide in communication with processor 552, so as to enable near area communication of device 550 with other devices. External interface 562 may provide, for example, for wired communication in some implementations, or for wireless communication in other implementations, and multiple interfaces may also be used.

The memory 564 stores information within the computing device 550. The memory 564 can be implemented as one or more of a computer-readable medium or media, a volatile memory unit or units, or a non-volatile memory unit or units. Expansion memory 574 may also be provided and connected to device 550 through expansion interface 572, which may include, for example, a SIMM (Single In Line Memory Module) card interface. Such expansion memory 574 may provide extra storage space for device 550, or may also store applications or other information for device 550. Specifically, expansion memory 574 may include instructions to carry out or supplement the processes described above, and may include secure information also. Thus, for example, expansion memory 574 may be provide as a security module for device 550, and may be programmed with instructions that permit secure use of device 550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 564, expansion memory 574, or memory on processor 552, that may be received, for example, over transceiver 568 or external interface 562.

Device 550 may communicate wirelessly through communication interface 566, which may include digital signal processing circuitry where necessary. Communication interface 566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 568. In addition, short-range communication may occur, such as using a Bluetooth, WiFi, or other such transceiver (not shown). In addition, GPS (Global Positioning System) receiver module 570 may provide additional navigation- and location-related wireless data to device 550, which may be used as appropriate by applications running on device 550.

Device 550 may also communicate audibly using audio codec 560, which may receive spoken information from a user and convert it to usable digital information. Audio codec 560 may likewise generate audible sound for a user, such as through a speaker, e.g., in a handset of device 550. Such sound may include sound from voice telephone calls, may include recorded sound (e.g., voice messages, music files, etc.) and may also include sound generated by applications operating on device 550.

The computing device 550 may be implemented in a number of different forms, as shown in the figure. For example, it may be implemented as a cellular telephone 580. It may also be implemented as part of a smart phone 582, personal digital assistant, or other similar mobile device.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by, or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. A portable computing device comprising:
a lid;
a base hingedly attached to the lid; and
a hinge at an intersection between the lid and the base, the hinge defining a recess configured to receive a stylus, the hinge including circuitry configured to provide electrical power to charge a battery in the stylus while the stylus is inside the recess.

2. The portable computing device of claim 1, wherein the lid comprises a display configured to receive input from the stylus.

3. The portable computing device of claim 1, wherein:
the lid comprises a display on a first side of the lid;
the base comprises a keyboard on a first side of the base; and
the hinge is configured to rotate the lid three hundred sixty degrees (360°) from a first position in which the display faces the keyboard to a second position in which a second side of the lid, opposite from the display, faces a second side of the base, opposite from the keyboard.

4. The portable computing device of claim 1, wherein the portable computing device comprises a laptop computer.

5. The portable computing device of claim 1, wherein the circuitry includes an electrical node configured to provide the electrical power to the stylus while the stylus is inside the recess.

6. The portable computing device of claim 1, wherein the circuitry is configured to provide the electrical power to a node that extends around a circumference of the stylus.

7. The portable computing device of claim 1, wherein the circuitry is configured to provide the electrical power to a node that is located at an end portion of the stylus.

8. The portable computing device of claim 1, wherein the circuitry is configured to provide a magnetic field to provide electrical power to the stylus while the stylus is inside the recess.

9. The portable computing device of claim 1, wherein the circuitry is further configured to provide firmware updates to the stylus.

10. The portable computing device of claim 1, further comprising the stylus inside the recess.

11. The portable computing device of claim 1, wherein:
the lid comprises a display configured to receive input from the stylus; and
the portable computing device further comprises the stylus inside the recess, the stylus being configured to provide input to the display.

12. The portable computing device of claim 1, wherein:
the lid comprises a display configured to receive input from the stylus; and
the portable computing device further comprises the stylus inside the recess, the stylus comprising a visual indicator and being configured to indicate a status of a battery inside the stylus via the visual indicator while the stylus is inside the recess.

13. The portable computing device of claim 1, wherein:
the circuitry is configured to send signals indicating a time of day to the stylus; and
the portable computing device further comprises the stylus inside the recess, the stylus comprising a display configured to display the time of day while the stylus is inside the recess.

14. The portable computing device of claim 1, wherein the hinge further comprises a retention mechanism configured to hold the stylus inside the recess.

15. The portable computing device of claim 1, wherein the circuitry is further configured to:
receive a battery status indicator signal from the stylus;
if the battery status indicator signal indicates that the battery is not fully charged, provide the electrical power to the stylus while the stylus is inside the recess; and
if the battery status indicator signal indicates that the battery is fully charged, not provide the electrical power to the stylus while the stylus is inside the recess.

16. A non-transitory computer-readable storage medium comprising instructions stored thereon for charging a stylus inside a portable computing device, the instructions, when executed by at least one processor, being configured to cause the portable computing device to at least:
determine whether a stylus is inside a recess defined by the portable computing device and is less than fully charged;
if the stylus is inside the recess defined by the portable computing device and is less than fully charged, provide electrical power to the stylus; and
if the stylus is not inside the recess defined by the portable computing device or if the stylus is fully charged, not provide electrical power to the stylus.

17. The non-transitory computer-readable storage medium of claim 16, wherein the instructions are further configured to cause the portable computing device to process a signal received from the stylus, the signal indicating whether the stylus is fully charged.

18. The non-transitory computer-readable storage medium of claim 16, wherein the instructions are further configured to cause the portable computing device to send a signal to the stylus, the signal indicating a time of day.

19. The non-transitory computer-readable storage medium of claim 16, wherein the instructions are further configured to cause the portable computing device to send a signal to the stylus, the signal including at least one firmware update.

20. A portable computing device comprising:
a lid comprising a display on a first side of the lid;
a base hingedly attached to the lid, the base comprising a keyboard on a first side of the base; and
a hinge at an intersection between the lid and the base, the hinge being configured to rotate the lid three hundred sixty degrees (360°) from a first position in which the display faces the keyboard to a second position in which a second side of the lid, opposite from the display, faces a second side of the base, opposite from the keyboard, the hinge defining a recess configured to receive a stylus, the portable computing device including circuitry configured to:
determine whether a stylus inside the recess is less than fully charged;
if the stylus is inside the recess and is less than fully charged, provide electrical power to the stylus;
if the stylus inside the recess is fully charged, not provide electrical power to the stylus; and
provide firmware updates to the stylus.
